(19) United States
(12) Patent Application Publication
(10) Pub. No.: US 2004/0007633 A1
(43) Pub. Date: Jan. 15, 2004

(54) Hand sprayer with optional extensions

(76) Inventor: Elliott Simmons, Plainfield, NJ (US)

Correspondence Address: Robert J. Ferb. Esq., 448 Union Avenue, Middlesex, NJ, 08846, US

(21) Appl. No.: 10/191,585

(22) Filed: Jul. 9, 2002

(51) Int. Cl. B05B 15/06

(52) U.S. Cl. 239/532

(57) ABSTRACT

A sprayer comprising a handle having a compressed air connection, a chemical connection, and a spray outlet, and containing a blocking means for preventing the compressed air and chemical from releasing through the spray outlet; a hose having two ends with one end of the hose connected to the compressed air connection of the handle; a compressor system connected to the other end of the hose; a trigger attached to the handle which engages and disengages the blocking means; a container attached to the chemical connection of the handle; an adapter having a first end, a second end and a bore running all the way through the adapter from the first end of the adapter to the second end of the adapter, with the first end of the adapter removably connected to the spray outlet of the handle; a tip having an attaching end, an outlet end, and a bore running all the way through the tip from the attaching end of the tip to the outlet end of the tip, with the attaching end of the tip removably connected to the second end of the adapter, with the bores allowing the chemical spray to be released through the outlet end of the tip; and which may be extended up to at least approximately six feet by using either one extension rod or two extension rods.

### BACKGROUND OF THE INVENTION

1. Field of the Invention

This invention relates generally to the spraying of a dry, cloudy chemical solution for various purposes, particularly for spraying in high or other hard to reach locations, and most particularly for spraying bugs, bees, wasps, insects, and other pests. The invention provides for a hand held sprayer for spraying such a solution in such locations. More specifically, the invention provides a sprayer comprising a handle 1 having a compressed air connection 2, a chemical connection 3 and a spray outlet 4, and containing a blocking means 5 for preventing the compressed air and chemical from releasing through the spray outlet 4; a hose 25 having two ends 26 & 27 with one end 26 of the hose 25 connected to the compressed air connection 2 of the handle 1; a compressor system 24 connected to the other end 27 of the hose 25; a trigger 6 attached to the handle 1 which engages and disengages the blocking means 5; a container 7 attached to the chemical connection 3 of the handle 1; an adapter 16 having a first end 17, a second end 18 and a bore 19 running all the way through the adapter 16 from the first end 17 of the adapter 16 to the second end 18 of the adapter 16, with the first end 17 of the adapter 16 removably connected to the spray outlet 4 of the handle 1; a tip 20 having an attaching end 21, an outlet end 22, and a bore 23 running all the way through the tip 20 from the attaching end 21 of the tip 20 to the outlet end 22 of the tip 20, with the attaching end 21 of the tip 20 removably connected to the second end 18 of the adapter 16, with the bores 11, 15, 19 & 23 allowing the chemical spray to be released through the outlet end 22 of the tip 20; and which may be extended up to at least approximately six feet by using either one extension rod 8 of approximately three feet in length, or one extension rod 8 of approximately six feet in length or two extension rods 8 & 12 with each extension rod 8 & 12 being approximately three feet in length.

2. Related Prior Art

The applicant is not aware of any prior art which discloses or teaches the unique features and combination of features of the current invention.

### SUMMARY OF THE INVENTION

The invention discloses and teaches a sprayer comprising a handle 1 having a compressed air connection 2, a chemical connection 3 and a spray outlet 4, and containing a blocking means 5 for preventing the compressed air and chemical from releasing through the spray outlet 4; a hose 25 having two ends 26 & 27 with one end 26 of the hose 25 connected to the compressed air connection 2 of the handle 1; a compressor system 24 connected to the other end 27 of the hose 25; a trigger 6 attached to the handle 1 which engages and disengages the blocking means 5; a container 7 attached to the chemical connection 3 of the handle 1; an adapter 16 having a first end 17, a second end 18 and a bore 19 running all the way through the adapter 16 from the first end 17 of the adapter 16 to the second end 18 of the adapter 16, with the first end 17 of the adapter 16 removably connected to the spray outlet 4 of the handle 1; a tip 20 having an attaching end 21, an outlet end 22, and a bore 23 running all the way through the tip 20 from the attaching end 21 of the tip 20 to the outlet end 22 of the tip 20, with the attaching end 21 of the tip 20 removably connected to the second end 18 of the adapter 16, with the bores 11, 15, 19 & 23 allowing the chemical spray to be released through the outlet end 22 of the tip 20; and which may be extended up to at least approximately six feet by using either one extension rod 8 or two extension rods 8 & 12.

It is a primary object of the current invention to provide a hand sprayer which utilizes compressed air and dry chemical to spray the chemical at the desired location, and which can be controlled by the user.

It is a further object of the current invention to provide a hand sprayer providing optional extensions of the spraying device to reach high and hard to reach locations, with the extension providing options of several lengths of at least up to six feet in length.

It is a further object of the current invention to provide a hand sprayer which is portable and easily used at remote locations.

It is a further object of the current invention to provide a means of quickly and easily extending the length of the hand sprayer.

These and other objects may become more apparent to those skilled in the art upon reviewing of this invention, and upon undertaking a study of the description of its preferred and other embodiments, and in view of the drawings.

### BRIEF DESCRIPTION OF THE DRAWINGS

FIG. 1 shows a side-view of the hand sprayer.

FIG. 2 shows an expanded side-view of the hand sprayer.

FIG. 3 shows a side-view of the handle 1.

FIG. 4 shows a side-view of the adapter 19.

FIG. 5 shows an end-view of the adapter 19.

FIG. 6 shows a side-view of the first extension rod 8.

FIG. 7 shows an end-view of the first extension rod 8.

FIG. 8 shows a side-view of the second extension rod 12.

FIG. 9 shows an end-view of the second extension rod 12.

FIG. 10 shows a side-view of the tip 20.

FIG. 11 shows an end-view of the tip 20.

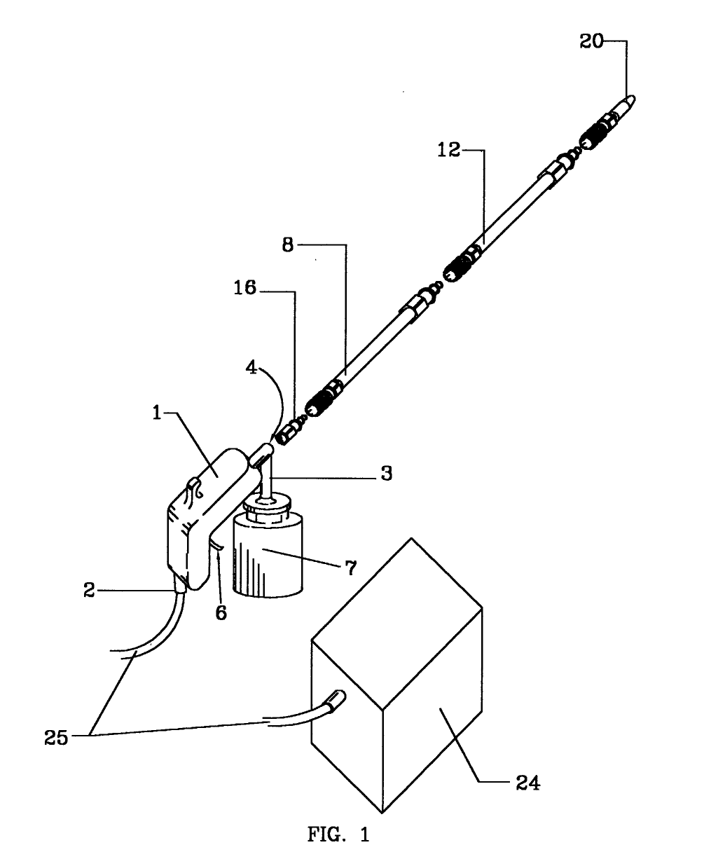

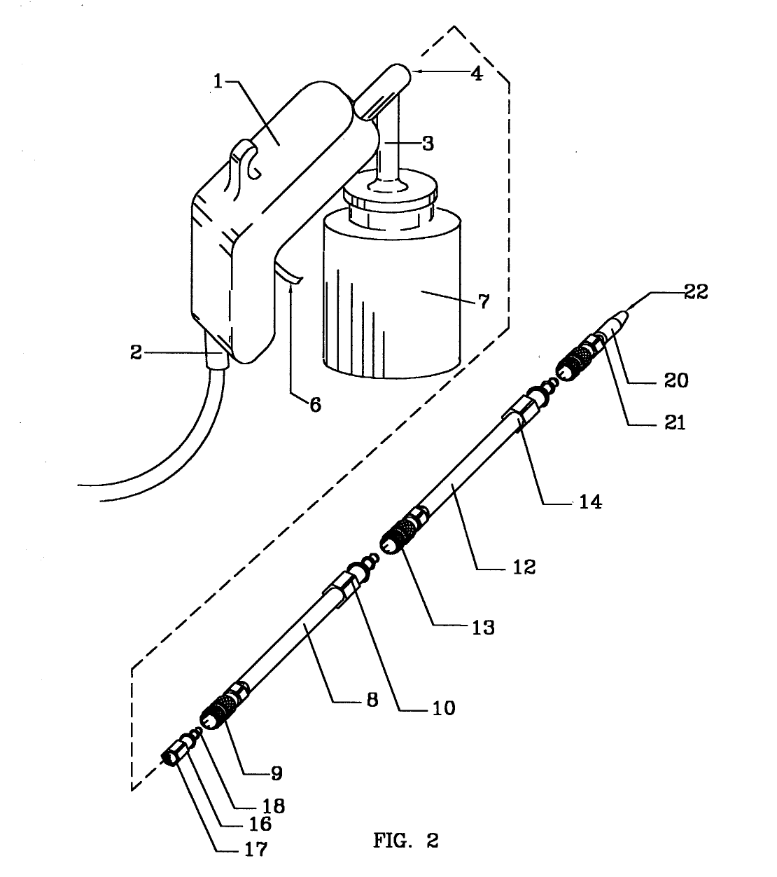

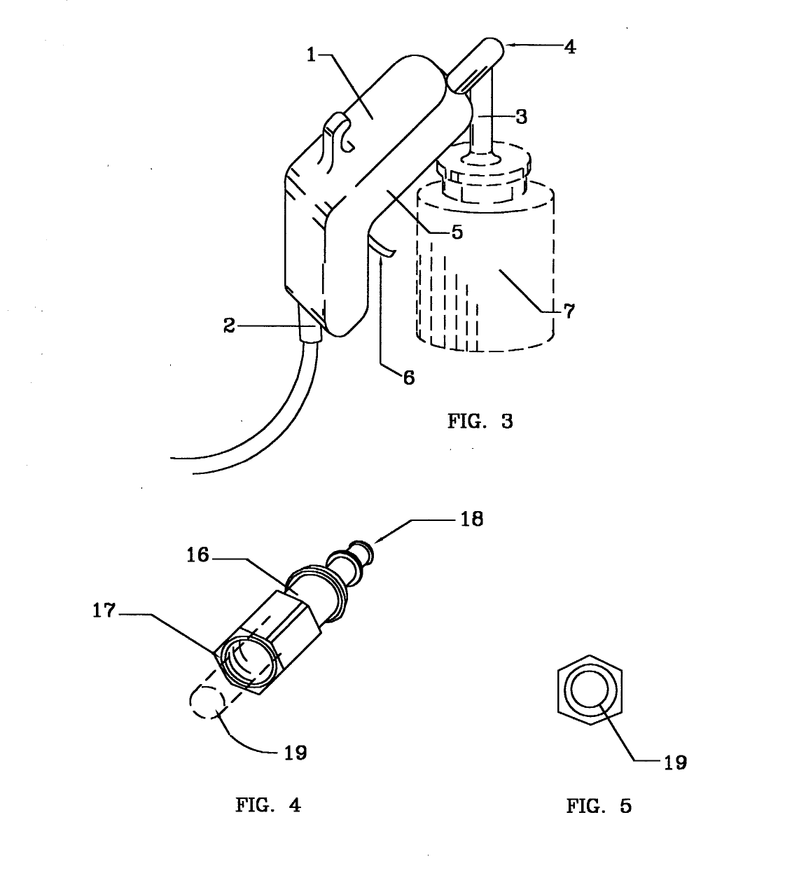

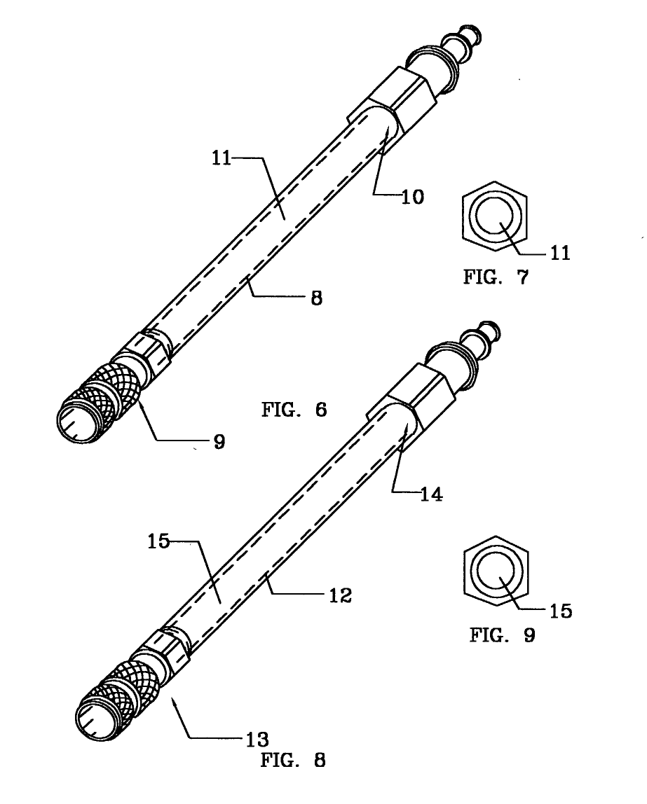

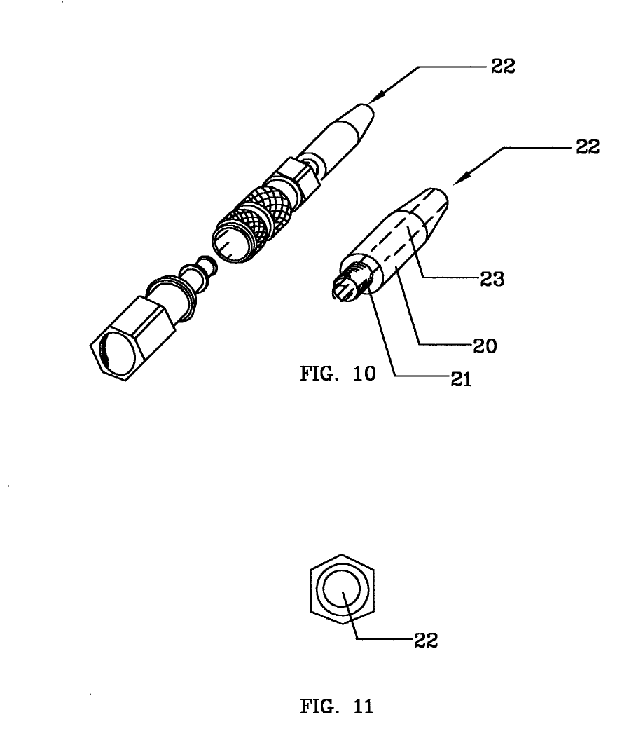

In the drawings and in this Specification, the following designations are used:

Handle 1

Compressed Air Connection of the Handle 2

Chemical Connection of the Handle 3

Spray Outlet of the Handle 4

Blocking Means 5

Trigger 6

Container 7

First Extension Rod 8

First End of the First Extension Rod 9

Second End of the First Extension Rod 10

Bore through the First Extension Rod 11

Second Extension Rod 12

First End of the Second Extension Rod 13

Second End of the Second Extension Rod 14

Bore through the Second Extension Rod 15

Adapter 16

First End of the Adapter 17

Second End of the Adapter 18

Bore through the Adapter 19

Tip 20

Attaching End of the Tip 21

Outlet End of the Tip 22

Bore through the Tip 23

Compressor System 24

Hose 25

First End of the Hose 26

Second End of the Hose 27

### DESCRIPTION OF THE PREFERRED EMBODIMENTS

The present invention is a hand sprayer. The preferred embodiment of the invention is a sprayer comprising a handle 1 having a compressed air connection 2, a chemical connection 3, and a spray outlet 4, and containing a blocking means 5 for preventing the compressed air and chemical from releasing through the spray outlet 4; a hose 25 having two ends 26 & 27 with one end 26 of the hose 25 connected to the compressed air connection 2 of the handle 1; a compressor system 24 connected to the other end 27 of the hose 25; a trigger 6 attached to the handle 1 which engages and disengages the blocking means 5; a container 7 attached to the chemical connection 3 of the handle 1; an adapter 16 having a first end 17, a second end 18 and a bore 19 running all the way through the adapter 16 from the first end 17 of the adapter 16 to the second end 18 of the adapter 16, with the first end 17 of the adapter 16 removably connected to the spray outlet 4 of the handle 1; a tip 20 having an attaching end 21, an outlet end 22, and a bore 23 running all the way through the tip 20 from the attaching end 21 of the tip 20 to the outlet end 22 of the tip 20, with the attaching end 21 of the tip 20 removably connected to the second end 18 of the adapter 16, with the bores 19 & 23 allowing the chemical spray to be released through the outlet end 22 of the tip 20; and which may be extended up to at least approximately six feet by using either one extension rod 8 of approximately three feet in length, or one extension rod 8 of approximately six feet in length or two extension rods 8 & 12 with each extension rod 8 & 12 being approximately three feet in length.

In a further embodiment of the invention, a sprayer is comprised of a handle 1 having a compressed air connection 2, a chemical connection 3, and a spray outlet 4, and containing a blocking means 5 for preventing the compressed air and chemical from releasing through the spray outlet 4; a hose 25 having two ends 26 & 27 with one end 26 of the hose 25 connected to the compressed air connection 2 of the handle 1; a compressor system 24 connected to the other end 27 of the hose 25; a trigger 6 attached to the handle 1 which engages and disengages the blocking means 5; a container 7 attached to the chemical connection 3 of the handle 1; an adapter 16 having a first end 17, a second end 18 and a bore 19 running all the way through the adapter 16 from the first end 17 of the adapter 16 to the second end 18 of the adapter 16, with the first end 17 of the adapter 16 removably connected to the spray outlet 4 of the handle 1; a first extension rod 8 having a first end 9, a second end 10 and a bore 11 running all the way through the first extension rod 8 from the first end 9 of the first extension rod 8 to the second end 10 of the first extension rod 8, with the first end 9 of the first extension rod 8 removably connected to the second end 18 of the adapter 16; a tip 20 having an attaching end 21, an outlet end 22, and a bore 23 running all the way through the tip 20 from the attaching end 21 of the tip 20 to the outlet end 22 of the tip 20, with the attaching end 21 of the tip 20 removably connected to the second end 10 of the first extension rod 8, with the bores 11, 19 & 23 allowing the chemical spray to be released through the outlet end 22 of the tip 20. The first extension rod 8 may be any length, but preferably is approximately three feet in length, but could also be approximately six feet in length.

In a further embodiment of the invention, a sprayer is comprised of a handle 1 having a compressed air connection 2, a chemical connection 3, and a spray outlet 4, and containing a blocking means 5 for preventing the compressed air and chemical from releasing through the spray outlet 4; a hose 25 having two ends 26 & 27 with one end 26 of the hose 25 connected to the compressed air connection 2 of the handle 1; a compressor system 24 connected to the other end 27 of the hose 25; a trigger 6 attached to the handle 1 which engages and disengages the blocking means 5; a container 7 attached to the chemical connection 3 of the handle 1; an adapter 16 having a first end 17, a second end 18 and a bore 19 running all the way through the adapter 16 from the first end 17 of the adapter 16 to the second end 18 of the adapter 16, with the first end 17 of the adapter 16 removably connected to the spray outlet 4 of the handle 1; a first extension rod 8 having a first end 9, a second end 10 and a bore 11 running all the way through the first extension rod 8 from the first end 9 of the first extension rod 8 to the second end 10 of the first extension rod 8, with the first end 9 of the first extension rod 8 removably connected to the second end 18 of the adapter 16; a second extension rod 12 having a first end 13, a second end 14 and a bore 15 running all the way through the second extension rod 12 from the first end 13 of the first extension rod 12 to the second end 14 of the first extension rod 12, with the first end 13 of the first extension rod 12 removably connected to the second end 10 of the first extension rod 9; a tip 20 having an attaching end 21, an outlet end 22, and a bore 23 running all the way through the tip 20 from the attaching end 21 of the tip 20 to the outlet end 22 of the tip 20, with the attaching end 21 of the tip 20 removably connected to the second end 14 of the second extension rod 12, with the bores 11, 15, 19 & 23 allowing the chemical spray to be released through the outlet end 22 of the tip 20. The first extension rod 8 may be any length, but preferably is approximately three feet in length, but could also be approximately six feet in length if it is the only extension rod used. The second extension rod 12 may be any length, but preferably is approximately three feet in length.

In any of the embodiments of the invention, any or all of the removable connections may be accomplished by using quick connections wherein a male end inserts directly into a female end without twisting or screwing and which locks in place by means of an exterior ridge on the male end fitting into a depression on the interior of the female end. Preferably, all of the removable connections are accomplished by such quick connections. Furthermore, preferably, the first end 17 of the adapter 16, the first end 9 of the first extension rod 8, the first end 13 of the second extension rod 12, and the attaching end 21 of the tip 20, all would have male ends. And consequently, the spray outlet 4 of the handle 1, the second end 18 of the adapter 16, the second end 10 of the first extension rod 8, the second end 14 of the second extension rod 12, and the outlet end 22 of the tip 20, would all have female ends. The male ends would then insert into the respective female ends as noted above.

In any of the embodiments of the invention, any or all of the removable connections could be accomplished by using threaded screws. With threaded screws, the first end 17 of the adapter 16, the first end 9 of the first extension rod 8, the first end 13 of the second extension rod 12, and the attaching end 21 of the tip 20, all would preferably have male threads. And consequently, the spray outlet 4 of the handle 1, the second end 18 of the adapter 16, the second end 10 of the first extension rod 8, the second end 14 of the second extension rod 12, and the outlet end 22 of the tip 20, would then all have female threads. The male threads would then screw into the respective female threads.

In any of the embodiments of the invention, the lengths of the first extension rod 8, the second extension rod 12, and the tip 20 could vary, but preferably, the first extension rod 8 is approximately three feet long, the second extension rod 12 is approximately three feet long, and the tip 20 is approximately six inches long. In addition, the first extension rod 8 could be approximately six feet long if it is used by itself without the second extension rod 12. As noted above, the invention may be used without either extension rod 8 nor 12, or with just the first extension rod 8, or with both extension rods 8 & 12.

In a further embodiment of the invention, the compressor system 24 may be a portable compressor system 24 which can be carried on the back of an individual user of the invention so that the invention would be more effectively portable. Preferably, the compressor system 24 would contain its own power source such as a battery or solar cell. However, the compressor system 24 may rely on an outside source of power such as an electrical outlet.

In the various embodiments of the invention, compressed air from the compressor system 24 is forced through the compressed air connection 2 of the handle 1 and stopped by the blocking means 5. Dry chemical is stored in the container 7 is allowed to pass into the handle 1 to mix with the compressed air through the chemical connection 3 of the handle 1. The dry chemical is also stopped by the blocking means 5. The trigger 6 engages and disengages the blocking means 5, such that when the trigger 6 disengages the blocking means 5, the compressed air is mixed with the dry chemical and forced through the spray outlet 4 of the handle 1. The mixture of compressed air and dry chemical is then forced through the bore 19 of the adapter 16, and then through the bore 11 of the first extension rod 8 if it is being utilized, and then through the bore 15 of the second extension rod 12 if it is being utilized, and finally through the bore 23 of the tip 20 and released into the air out the outlet end 22 of the tip 20.

Variations or modifications to the subject matter of this invention may occur to those skilled in the art upon reviewing the disclosure as provided herein. Any variations, which are yet within the scope of the development as described, are intended to be encompassed within the invention. The descriptions of the preferred and other embodiments as provided herein are set forth for illustrative purposes only.

Having set forth the general nature and specific embodiments of the present invention, the true scope is now particularly pointed out in the appended claims.

What is claimed is:

1. A sprayer comprising:
a handle having a compressed air connection, a chemical connection and a spray outlet, and containing a blocking means for preventing the compressed air and chemical from releasing through the spray outlet;
a hose having two ends with one end of the hose connected to the compressed air connection of the handle;
a compressor system connected to the other end of the hose;
a trigger attached to the handle which engages and disengages the blocking means;
a container attached to the chemical connection of the handle;
an adapter having a first end, a second end and a bore running all the way through the adapter from the first end of the adapter to the second end of the adapter, with the first end of the adapter removably connected to the spray outlet of the handle; and
a tip having an attaching end, an outlet end, and a bore running all the way through the tip from the attaching end of the tip to the outlet end of the tip, with the attaching end of the tip removably connected to the second end of the adapter.

2. The sprayer according to claim 1, wherein:
all of the removable connections are accomplished by quick connections wherein a male end inserts directly into a female end without twisting or screwing and which locks in place by means of an exterior ridge on the male end fitting into a depression on the interior of the female end.

3. The sprayer according to claim 1, wherein:
the tip is approximately six inches in length.

4. The sprayer according to claim 1, wherein:
the compressor system is portable and able to be carried on the back of an individual.

5. The sprayer according to claim 1, wherein:
all of the removable connections are accomplished by quick connections wherein a male end inserts directly into a female end without twisting or screwing and which locks in place by means of an exterior ridge on the male end fitting into a depression on the interior of the female end; and
the tip is approximately six inches in length.

6. The sprayer according to claim 1, wherein:
all of the removable connections are accomplished by quick connections wherein a male end inserts directly into a female end without twisting or screwing and which locks in place by means of an exterior ridge on the male end fitting into a depression on the interior of the female end;
the tip is approximately six inches in length; and
the compressor system is portable and able to be carried on the back of an individual.

7. A sprayer comprising:
a handle having a compressed air connection, a chemical connection and spray outlet, and containing a blocking means for preventing the compressed air and chemical from releasing through the spray outlet;
a hose having two ends with one end of the hose connected to the compressed air connection of the handle;
a compressor system connected to the other end of the hose;
a trigger attached to the handle which engages and disengages the blocking means;
a container attached to the chemical connection of the handle;
an adapter having a first end, a second end and a bore running all the way through the adapter from the first end of the adapter to the second end of the adapter, with the first end of the adapter removably connected to the spray outlet of the handle;
a first extension rod having a first end, a second end, and a bore running all the way through the first extension rod from the first end of the first extension rod to the second end of the first extension rod, with the first end of the first extension rod removably connected to the second end of the adapter; and
a tip having an attaching end, an outlet end, and a bore running all the way through the tip from the attaching end of the tip to the outlet end of the tip, with the attaching end of the tip removably connected to the second end of the first extension rod.

8. The sprayer according to claim 7, wherein:
all of the removable connections are accomplished by quick connections wherein a male end inserts directly into a female end without twisting or screwing and which locks in place by means of an exterior ridge on the male end fitting into a depression on the interior of the female end;
the first extension rod is approximately three feet in length; and
the tip is approximately six inches in length.

9. The sprayer according to claim 7, wherein:
all of the removable connections are accomplished by quick connections wherein a male end inserts directly into a female end without twisting or screwing and which locks in place by means of an exterior ridge on the male end fitting into a depression on the interior of the female end;
the first extension rod is approximately six feet in length; and
the tip is approximately six inches in length.

10. The sprayer according to claim 7, wherein:
the compressor system is portable and able to be carried on the back of an individual.

11. The sprayer according to claim 7, wherein:
all of the removable connections are accomplished by quick connections wherein a male end inserts directly into a female end without twisting or screwing and which locks in place by means of an exterior ridge on the male end fitting into a depression on the interior of the female end;
the first extension rod is approximately three feet in length;
the tip is approximately six inches in length; and
the compressor system is portable and able to be carried on the back of an individual.

12. The sprayer according to claim 7, wherein:
all of the removable connections are accomplished by quick connections wherein a male end inserts directly into a female end without twisting or screwing and which locks in place by means of an exterior ridge on the male end fitting into a depression on the interior of the female end;
the first extension rod is approximately six feet in length;
the tip is approximately six inches in length; and
the compressor system is portable and able to be carried on the back of an individual.

13. A sprayer comprising:
a handle having a compressed air connection, a chemical connection and a spray outlet, and containing a blocking means for preventing the compressed air and chemical from releasing through the spray outlet;
a hose having two ends with one end of the hose connected to the compressed air connection of the handle;
a compressor system connected to the other end of the hose;
a trigger attached to the handle which engages and disengages the blocking means;
a container attached to the chemical connection of the handle;
an adapter having a first end, a second end and a bore running all the way through the adapter from the first end of the adapter to the second end of the adapter, with the first end of the adapter removably connected to the spray outlet of the handle;
a first extension rod having a first end, a second end, and a bore running all the way through the first extension rod from the first end of the first extension rod to the second end of the first extension rod, with the first end of the first extension rod removably connected to the second end of the adapter;
a second extension rod having a first end, a second end, and a bore running all the way through the second extension rod from the first end of the second extension rod to the second end of the second extension rod, with the first end of the second extension rod removably connected to the second end of the first extension rod; and
a tip having an attaching end, an outlet end, and a bore running all the way through the tip from the attaching end of the tip to the outlet end of the tip, with the attaching end of the tip removably connected to the second end of the second extension rod.

14. The sprayer according to claim 13, wherein:
all of the removable connections are accomplished by quick connections wherein a male end inserts directly into a female end without twisting or screwing and which locks in place by means of an exterior ridge on the male end fitting into a depression on the interior of the female end.

15. The sprayer according to claim 13, wherein:
the first extension rod and the second extension rod are both approximately three feet in length; and
the tip is approximately six inches in length.

16. The sprayer according to claim 13, wherein:
the compressor system is portable and able to be carried on the back of an individual.

17. The sprayer according to claim 13, wherein:
all of the removable connections are accomplished by quick connections wherein a male end inserts directly into a female end without twisting or screwing and which locks in place by means of an exterior ridge on the male end fitting into a depression on the interior of the female end;
the first extension rod and the second extension rod are both approximately three feet in length; and
the tip is approximately six inches in length.

18. The sprayer according to claim 13, wherein:
all of the removable connections are accomplished by quick connections wherein a male end inserts directly into a female end without twisting or screwing and which locks in place by means of an exterior ridge on the male end fitting into a depression on the interior of the female end;
the first extension rod and the second extension rod are both approximately three feet in length;
the tip is approximately six inches in length; and
the compressor system is portable and able to be carried on the back of an individual.
